(19) United States
(12) Patent Application Publication
(10) Pub. No.: US 2006/0286534 A1
(43) Pub. Date: Dec. 21, 2006

(54) Enhanced computer-based training program/content editing portal

(75) Inventors: JeffRoy Hamilton Tillis, Studio City, CA (US); Gregory Lee Abbott, Reseda, CA (US)

Correspondence Address: DAVIDSON BERQUIST JACKSON & GOWDEY LLP, 4300 WILSON BLVD., 7TH FLOOR, ARLINGTON, VA, 22203, US

(73) Assignee: ITT Industries, Inc., Van Nuys, CA (US)

(21) Appl. No.: 11/145,970

(22) Filed: Jun. 7, 2005

(51) Int. Cl. G09B 3/00

(52) U.S. Cl. 434/350

(57) ABSTRACT

A system for computer-based training (“CBT”) includes a content editing portal, operable on a computer system, for generating content using a markup language, the portal providing a graphical user interface (“GUI”) to give a user access to the markup language date in a structured form-based editing environment. The portal supports: making changes to the content; creating an index of the content; associating a procedure with a page of content; adding audio to the content; and adding titles to the content. An acronyms module supports the creation of a list of acronyms; and a testing module which supports the creation of tests. Content is stored using templates, and the GUI supports reassigning the content from a first template to a second template by selection of a template tab corresponding to the second template. A presentation mechanism presents a lesson to a user, the lesson having been stored using structural templates including at least one lesson template and at least one testing template. The presentation mechanism presents a plurality of panels, including a global acronym panel. A drilldown mechanism provides a user with additional pages of information related to a selected topic.

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### FIELD OF THE INVENTION

This invention relates computer-based training. More specifically, this invention relates to an enhanced computer-based training (“ECBT”) interface (“C-PORT”) content editing portal.

### BACKGROUND

Computer-based training (“CBT”) is used in many fields and applications, and CBT systems (also referred to as Computer-Aided Instruction—CAI—systems) have been around for decades. Typical CBT systems provide a user with subject matter displayed within a user interface, content management tools for training curricula and content editing tools for instructional material. However, typical CBT systems provide limited interactivity and little or no direct access to information. Content editing tools are limited in scope and in their ability to integrate user-defined fields.

The present invention overcomes these and other deficiencies in prior CBT systems by providing users with direct access to information and enhanced interactivity, providing a user greater control over their experience. In addition, the present invention provides for content editing using a custom interface for simple and direct interaction with training content. Accordingly, in one aspect, this invention provides novel methods, systems and devices to support program and content development for such systems. In another aspect, this invention provides an ECBT system that uses the content so developed.

### BRIEF DESCRIPTION OF THE DRAWINGS

For a more complete understanding of the present invention and the advantages thereof, reference should be made to the following Detailed Description taken in connection with the accompanying drawings, in which:

FIG. 1 shows a typical computer system supporting an ECBT program/content editing portal according to embodiments of the present invention;

FIGS. 2-4 show display screens from the Graphical User Interface of the content editing portal (“C-PORT”) according to embodiments of the present invention;

FIGS. 5(a)-5(w) show ECBT screens according to embodiments of the present invention.

### DETAILED DESCRIPTION OF PRESENTLY PREFERRED EXEMPLARY EMBODIMENTS OF THE INVENTION

ECBT Program/Content Editing Portal

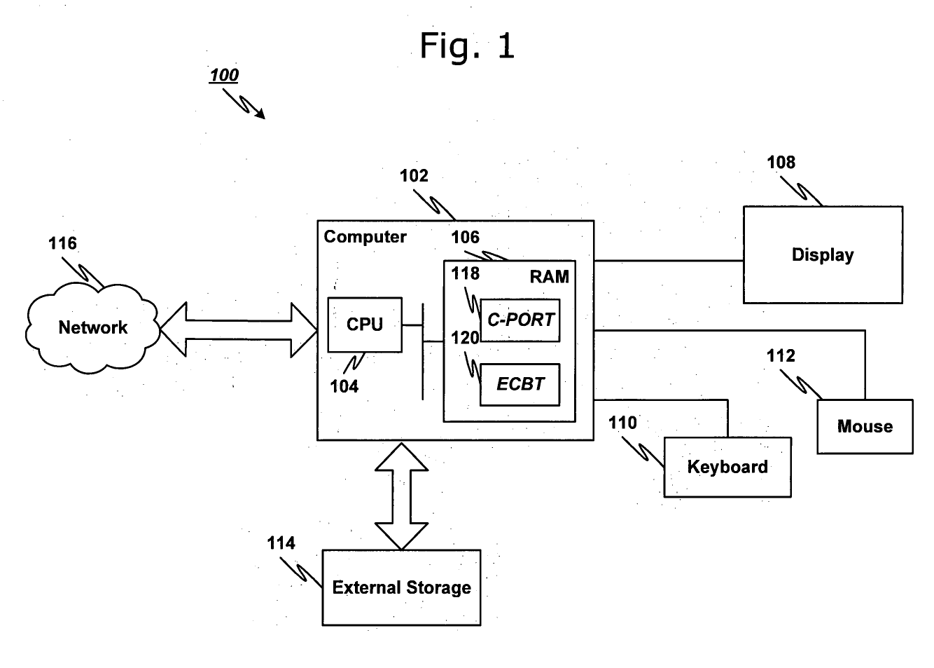

The ECBT interface/content editing portal (“C-PORT”) according to embodiments of the present invention operates on a typical computer system, such as, e.g., on a computer system 100 as shown in FIG. 1. Computer system 100 includes a computer 102 with a processor (CPU) 104 and memory (RAM) 106. The computer 102 preferably includes at least one display 108, a keyboard 110 and pointing device (such as mouse 112). The computer 102 is connectable to internal or external storage 114 (which may include disks, and other known types of internal or external storage devices). In addition, the computer 102 may be connectable to a network 116 which may be a WAN, LAN or any other type of network. The network may be the Internet. The software that embodies the C-PORT system according to embodiments of the present invention operates in a conventional manner by being loaded into the memory 106 of the computer 102. (The code representing the C-PORT application is denoted 118 in FIG. 1.) The instructions are then executed in a known manner by the processor—CPU 104.

Embodiments of the invention use a markup language to generate and store content. Presently preferred embodiments of the C-PORT application 118 use XML (Extensible Markup Language). XML is a standard for creating markup languages which describe the structure of data. XML is like SGML (Standard Generalized Markup Language) in that it is a meta-language, or a language for describing languages. XML enables authors to define their own tags. XML provides information and services to be encoded with meaningful structure and semantics that computers and humans can understand. In general, as long as a programmer has the XML definition for a collection of data (often called a “schema”) then they can create a program to reliably process any data formatted according to those rules. The current version of XML is defined in http://www.w3.org/TR/2004/REC-xml11-20040204/, the contents of which are hereby incorporated herein by reference. Those skilled in the art will realize that other markup languages or mechanisms of representing data, now known or to be developed in the future, are within the scope of this invention, and that the invention is not to be limited by XML or any current version thereof.

The C-PORT application, according to embodiments of the present invention, provides a controlled and structured template-based solution to developing ECBT courses. The user starts the C-PORT application in a typical manner, depending on the underlying operating system of the computer.

If the default course files are not loaded or to open a course file, the user selects the “OPEN” link which causes an “Open File” dialog box to appear. The user may then search for the XML document containing the requested course material to be edited/authored. When the user has selected a document, he selects “Ok” to continue.

In presently preferred embodiments of the invention, the C-PORT environment provides a graphical user interface (“GUI”) to provide a user access to the XML data in a structured, form-based editing screen. As those skilled in the art will understand, the GUI is presented on display 108 of the computer system 100. The user interacts with the GUI in a known manner using the keyboard 110, mouse 112 and any other input devices that provide the user to select portions of the GUI and enter text into fields of the GUI. As used herein, with reference to a GUI item, the term “select” generally means to select the item in any known manner. For example, an icon may be selected using a mouse to move a cursor over the item or the same icon may be selected by using a TAB key to position the cursor of the item. Those skilled in the art will understand that the terms “select” and “click” are sometime synonymous, the latter referring to a particular method of selecting.

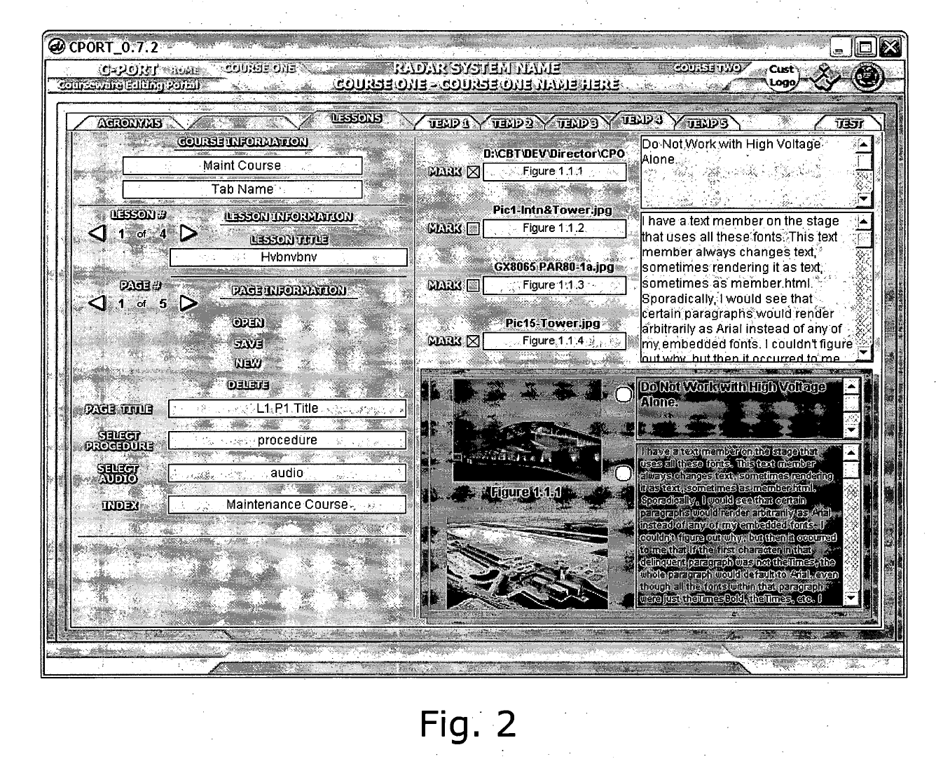

FIG. 2 shows a C-PORT application GUI according to embodiments of the present invention, as displayed on the display 108 of a computer system 100. As may be seen in FIG. 2, the GUI preferably includes a number of tabs along the top (e.g., in the example shown: “ACRONYMS”, “LESSONS”, “TEMP1”, “TEMP2”, “TEMP3”, “TEMP4”, “TEMP5”, and “TEST”). In FIG. 2 the “TEMP4” tab has been selected. The GUI also includes a number of fields, including, in the example shown: Course Information, Lesson Information (Lesson Title, Page Title, Select Procedure, Select Audio, Index).

The C-PORT GUI may be used to create and/or change lesson content. To change text in the “Course Title,” “Course” tab name, “Lesson title,”, or “Page title” fields, the user may use the tab key to move to or select within the text area to be changed and enter the new value.

Index: Each page may be assigned its own index reference from which ECBT may build its index list. An Index field (lower left of FIG. 2) provides the user with an option to create an index entry for the page. The index list is preferably dynamic and, like the Table of Contents (TOC), changes when the content changes. There is thus no need for a user to edit anything other than the page content for the appropriate index entry to change. In the example shown in FIG. 2, the Index entry is “Maintenance Course”. To create an index reference for the page, the user may enter the word or phrase that the dynamic ECBT index reference should show. If the field is left blank then there will be no reference in the ECBT Index list for the corresponding page.

Procedures: Each page in the ECBT may be assigned a procedure. The procedure is a custom set of instructions associated with the page. In presently preferred embodiments of the invention, the procedures are developed within the Macromedia Flash® development environment provided by Macromedia of California. (Flash® is a registered trademark of Macromedia, Inc.) The Flash® development environment produces a so-called Flash® file (presently a file ending in “.swf” on some computer systems). Using the “Select Procedure” field of the C-PORT application GUI, a procedure (e.g., Flash®) file may be assigned to a page within the lesson in order to provide expanded capabilities to the student. This feature brings both training and technical procedures together in one platform. To attach a procedure to a page the user selects the “Select Procedure” link. This causes a “Choose a Procedure” dialog box to open and provides the user with the ability to select a procedure for that ECBT Page. Once the user has located and selected the procedure of choice, he may select “Open” to continue.

Audio: Training may be augmented with assets other than pictures and text. Audio elements can enhance dynamic content by providing sound to help the student have a better understanding of the training material. In the C-PORT application each page may be assigned its own audio file, using the “Select Audio” field. Audio files may be unique or may be shared with other pages. In a presently preferred implementation, to attach an audio file to a page, the user selects the “Select Audio” link. The “Choose an Audio File” dialog box opens and provides the user with the ability to select an audio file for that ECBT Page. Once the user has located and selected the audio file of choice, select “Open” to continue. A current implementation of the C-PORT application recognizes “.wav” files as acceptable audio files.

Titles: Course, Lesson, and Page titles are displayed and edited from the C-PORT main form. These values are preferably stored within the XML data structure so as to provide the ECBT to use the information. For example, the ECBT may use this information for page headers, thumbnails and a TOC which may be generated dynamically from the XML data. For example, when the lesson curriculum is changed the TOC changes with it.

Templates: A major focus of the C-PORT application is control over content. Content is preferably structured so that it is reusable. Once data are stored, the C-PORT populates any of the installed ECBT templates. Once a template is populated with the ECBT content, it may be stored on demand into the XML document. Within the C-PORT application, changing templates may be done with a click of the mouse. Content may be reassigned to another template by loading the page into the C-PORT then selecting any one of the template tabs. The content is instantly repurposed into the selected template. For example, as shown in FIG. 2, the GUI provides five templates (labeled “TEMP1”, “TEMP2”, “TEMP3”, “TEMP4”, “TEMP5”). The currently active template in the figure is TEMP4. In order to reassign the content of this tab to another template, the user merely selects another template tab and saves the page.

Image Labels: The editing environment gives a user control over both image selection and assignment and the labeling of the images being displayed. A portion of the C-PORT GUI screen is provided to give the user a view of the actual page layout. This provides a dynamic representation of how the page will actually be displayed within the ECBT course, providing a valuable and necessary element enabling the content editor to visualize the lesson page as it would be displayed through the ECBT interface.

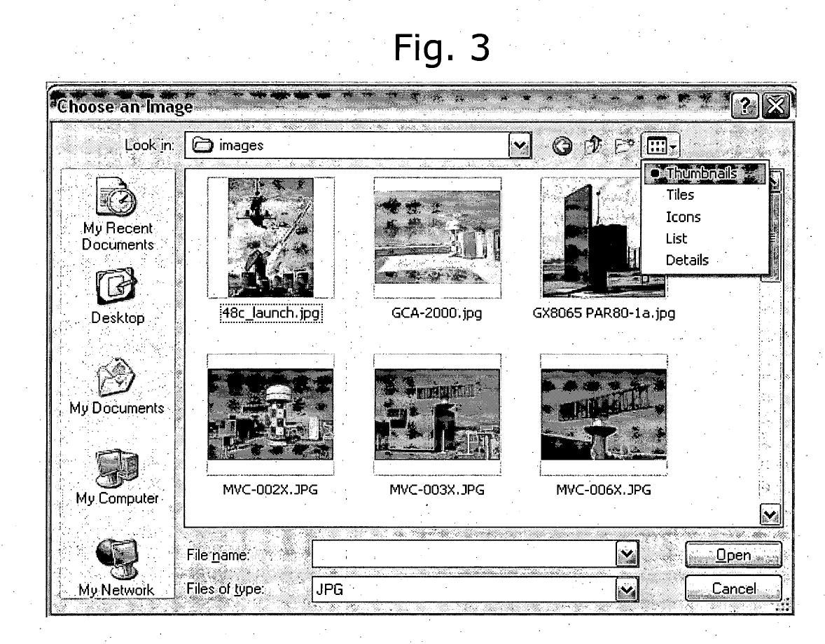

Each image has associated text located just beneath the image in the Page Preview area. To edit this text the user selects the text above the image file name. This is located just below the Template selection tabs near the top of the C-PORT application. While editing image labels, main text, or warnings text, C-PORT preferably dynamically updates the text within the Page Preview area. To change images within the Page Preview area, the user may select the image to be changed. The “Choose an Image” dialog box (shown in FIG. 3) appears. The user may then select the image to use and select “Open” to include that image. File dialog boxes used by the C-PORT application may have the ability to display files in thumbnails, tiles, icons, list and details. Thumbnails are especially helpful with browsing images.

Acronyms Module: Acronyms may be used throughout a training course. Initially acronyms are defined, although an acronym may be used repeatedly without its description. The Acronyms module provides a tool to develop the acronyms list in a sharable document structure. This provides the ECBT with the ability to reuse the acronym data throughout the ECBT application.

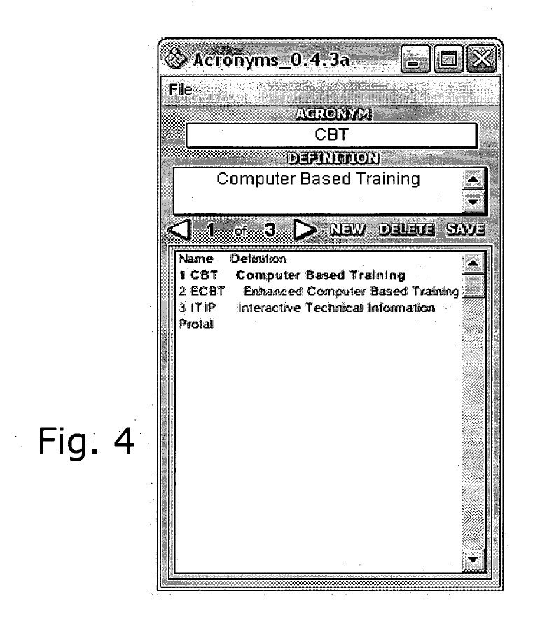

The acronyms feature provides a form-based approach to creating and editing acronyms for the ECBT. The acronyms list is preferably stored in separate XML documents. This approach provides flexibility to use the acronym module to generate and edit multiple XML-structured acronym lists. The acronyms module may be accessed from within the C-PORT application as well as independently. To access the acronyms module from within the C-PORT application, the user selects the “ACRONYMS” tab from the GUI. This causes the system to present the user with an acronyms entry screen as shown in FIG. 4. The acronym screen includes an ACRONYM field and a DEFINITION field. A list of currently defined acronyms is provided. To move through the acronym list the user selects the left or right arrows. A currently selected acronym is displayed bold in the acronym list window. All changes and additions to the acronyms list are stored in temporary memory. To save the acronym list to an XML document, the user selects the “SAVE” button in the user interface or the “Save” option from the “File” menu.

To add an acronym to the list, the user selects the “NEW” button. All new acronyms are inserted in front of the currently displayed acronym. To add a new acronym to the end of the list, select the right arrow until the last acronym in the list is reached. Every click of the right arrow beyond the last acronym adds a new record.

To jump to a particular acronym type the record number into the Acronym record number field. The Acronym and Definition fields may be edited by tabbing to or clicking inside the field. In a present implementation, the acronym is a single line of data up to fifteen characters. The definition field is a multi-line scrolling field.

To delete a selected acronym, select the “DELETE” button. A confirmation box appears. Deleting a record may also be accomplished by selecting the “Delete” option from the “File” menu. To exit the Acronyms module select the close button (“X”, in the top right corner) or select “Close” from the “File” menu. Using the Acronyms editing interface provides a user to create and edit a global acronyms list in a controlled structured format. The acronym information is stored in a separate XML document so it may be exported and imported into third party applications.

Testing Module: The C-PORT application includes tools to generate testing elements for the deployed ECBT. To enter the Testing Module the user selects the “Test” tab (at the top of the C-PORT interface next to the Template tabs). This selection causes the system to present the user with a Test GUI. Within this Test GUI, the user selects the “RELATED LESSON” dropdown box to specify a lesson from which this test will be referenced. The user is able to enter a test name and a passing score. To input or change text for the Test Name or Passing Score, the user selects within the text area to be changed and enters the new value. The user may input section names in a test. To input section names, the user selects the Sections tab and enters the title of each section to be used. The Number of Questions text area is defined for the user by C-PORT as the test is developed. To populate the questions, choices and answers, the user selects the Questions tab, selects which question type to be used for the current question. Presently preferred exemplary embodiments of the invention implement five question types, namely True/False, Multiple, Fill In, Hot Object and Drag and Drop. Having selected a question type, the user then enters a question in the question field. If the question type requires choices (Multiple Choice, Drag and Drop, Hot Object), then the user provides either the textual choices, or the paths to the picture choices. Otherwise, for True/False type questions, the user selects the correct answer. For Fill In type questions, the user provides the correct answer. To navigate to the next or a previous question, the user may use the Question number arrows or enter the question to jump to in the Question Number type area. Changes are saved in memory until the application is closed. To save changes to the file, the user selects the “Save” button. All changes to the test are saved to the XML document.

The C-PORT application provides an instructor and content developer with flexible control over the ECBT Content. The C-PORT application may load CBT content into the structured XML document, thereby facilitating several features for displaying the content in the ECBT course material.

To change the content within the main text or the warnings text fields, the user may use the tab to move to or select within the fields to edit content. The user cannot edit text in the Page Preview area.

Content developed using the C-PORT application may be saved on an external storage device for subsequent use.

The ECBT

The ECBT according to embodiments of the present invention operates on any standard computer system such as that shown in FIG. 1 which shows the ECBT 120 in the memory of the computer system 100. Those skilled in the art will realize that the C-PORT and ECBT will most likely be run on different computer systems.

Content (lessons) is developed and authored using the C-PORT application described above and then run by a user. It should be apparent that a user of the C-PORT application is a content developer/author, whereas a user of the ECBT system is a student, using content developed by an author/developer.

For the ECBT, the computer system 100 preferably has at least a 15 inch monitor with 800×600 resolution minimum. A 21 inch monitor with 1280×1024 resolution is optimal (and recommended). In a present implementation, the operating system is Microsoft's Windows 98, Windows 2000, or Windows XP.

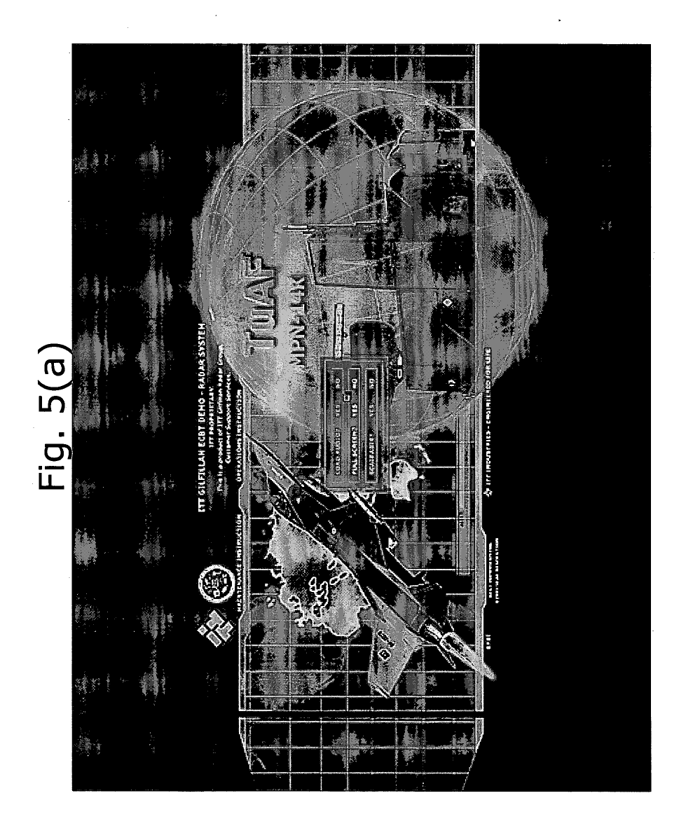

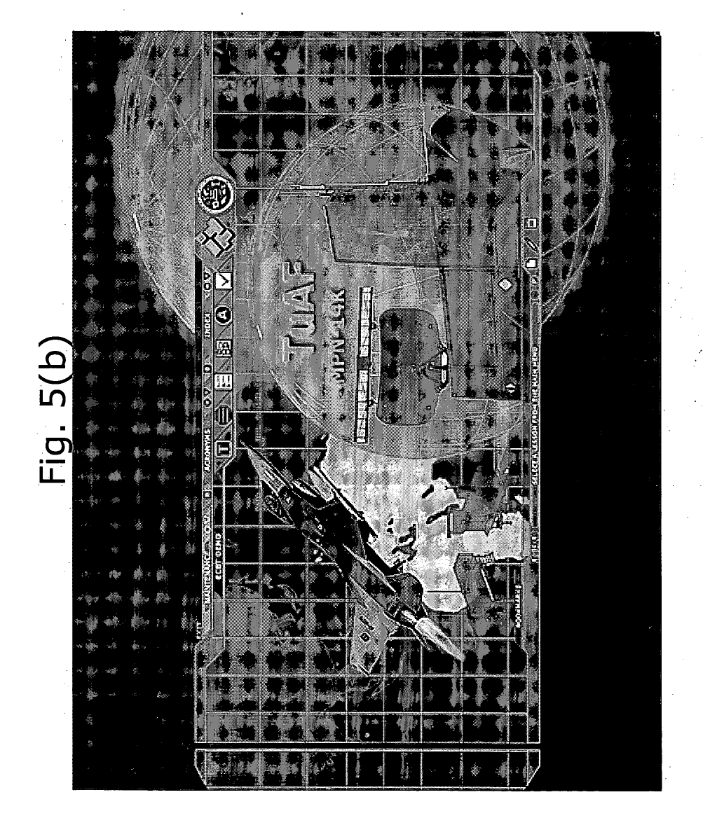

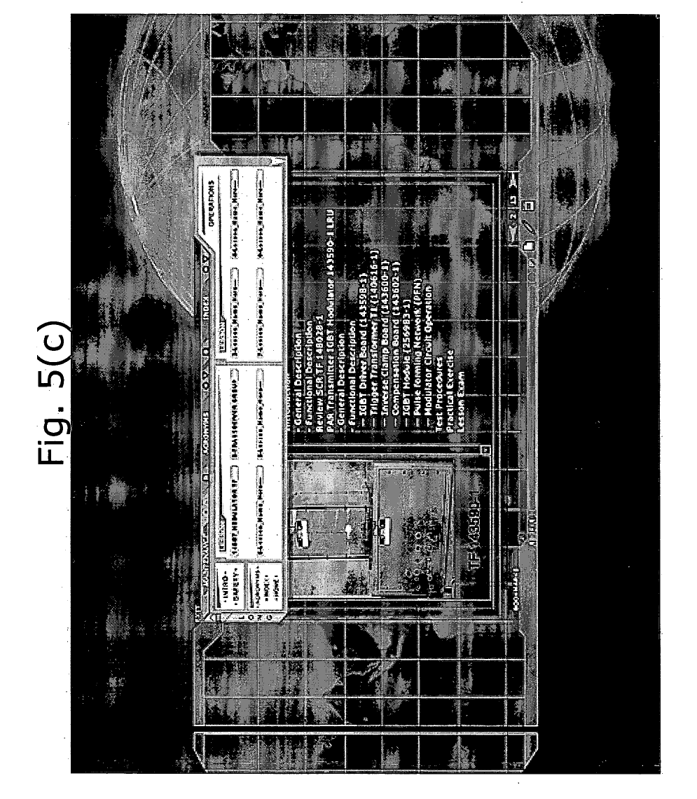

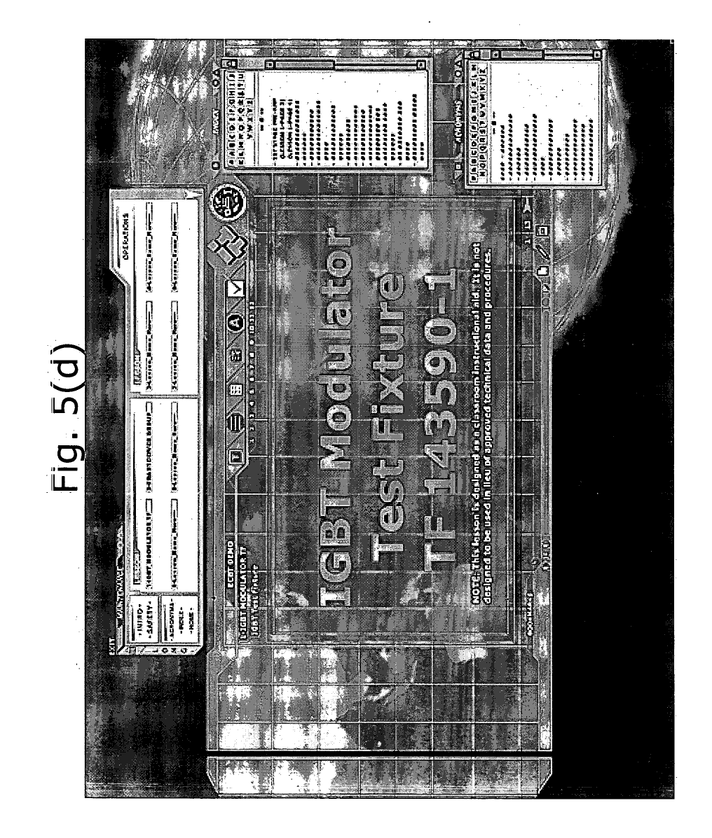

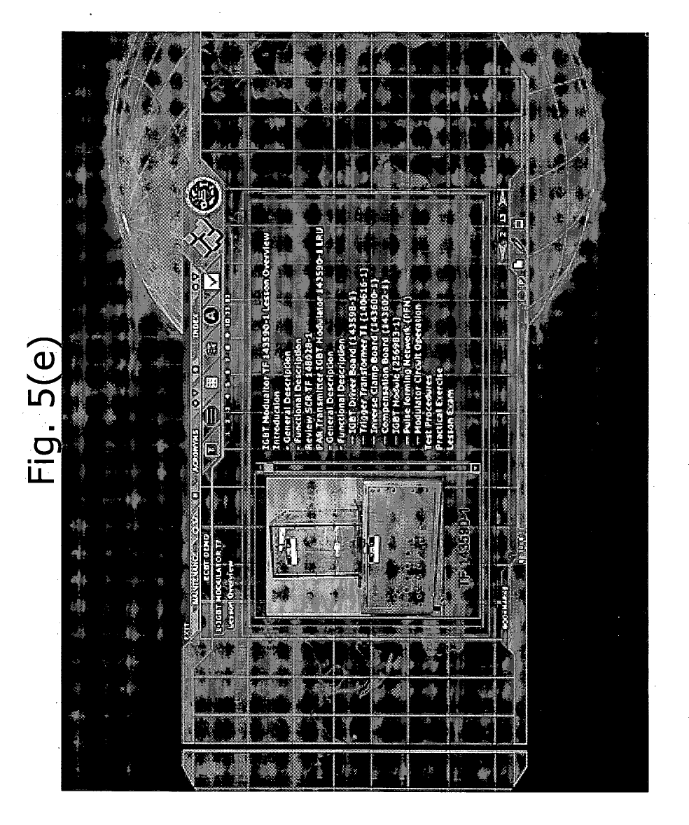

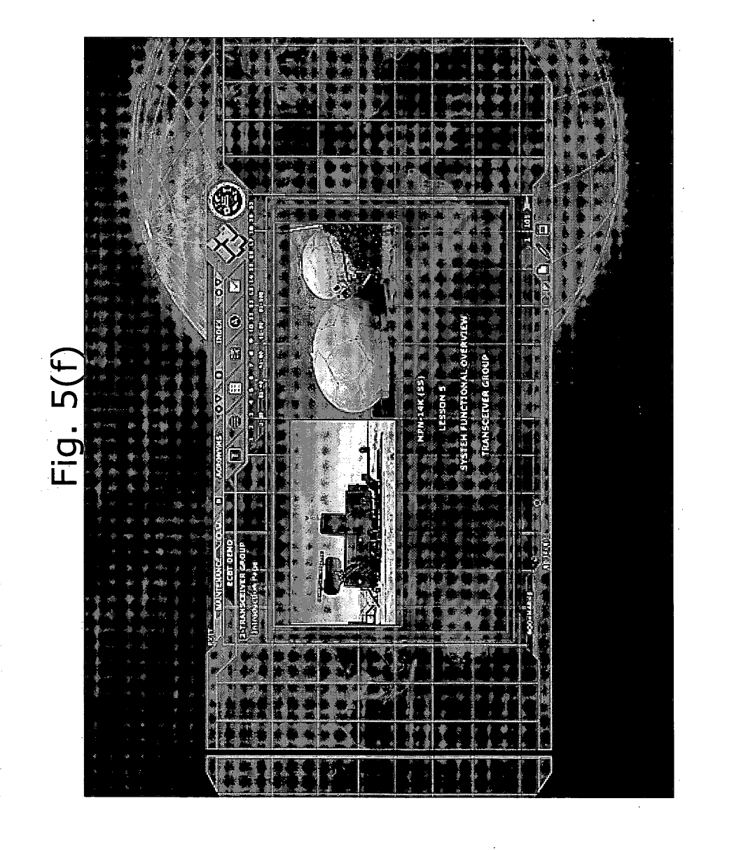

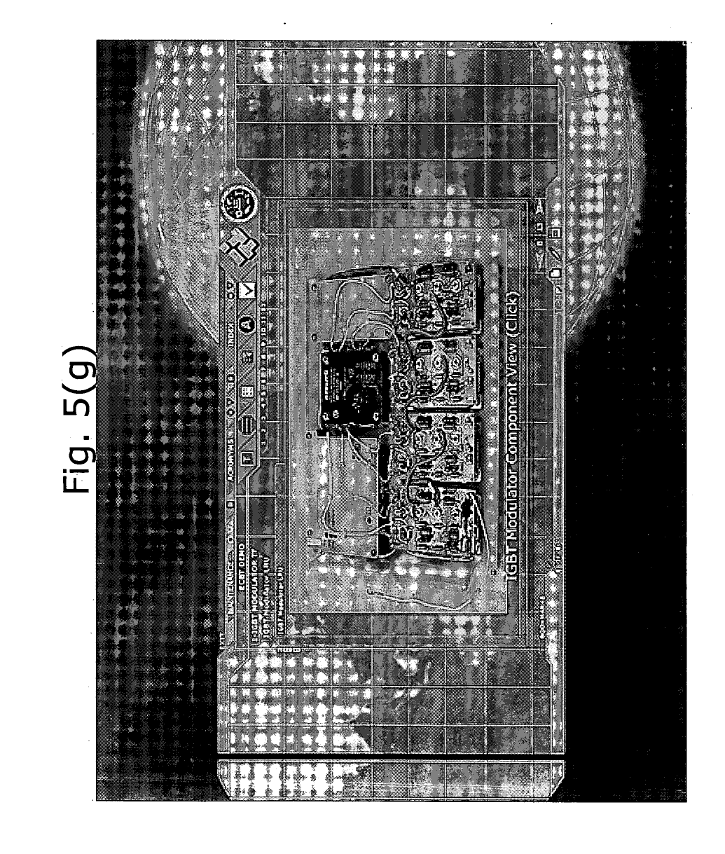

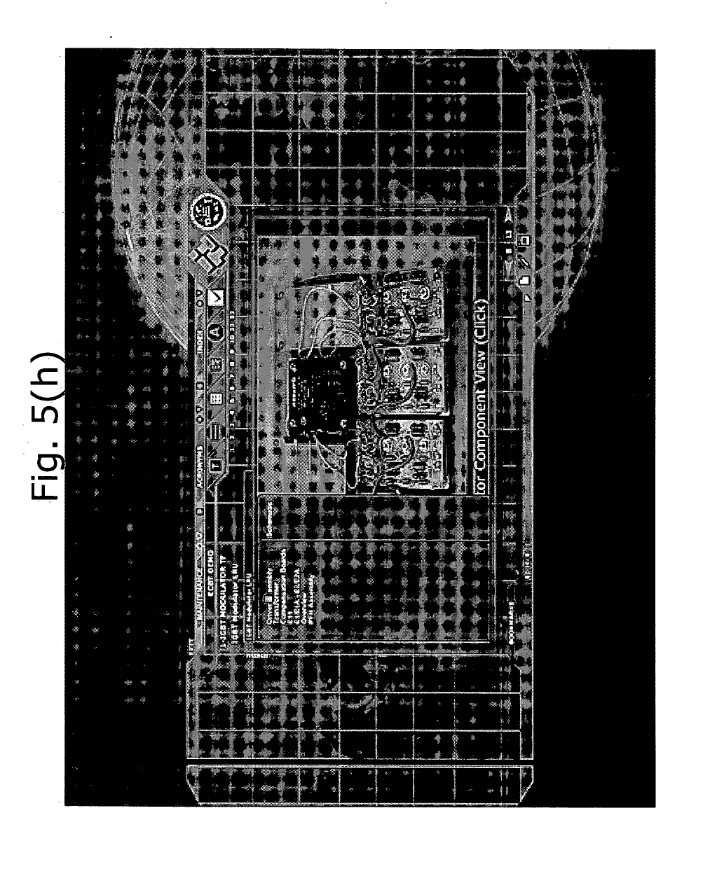

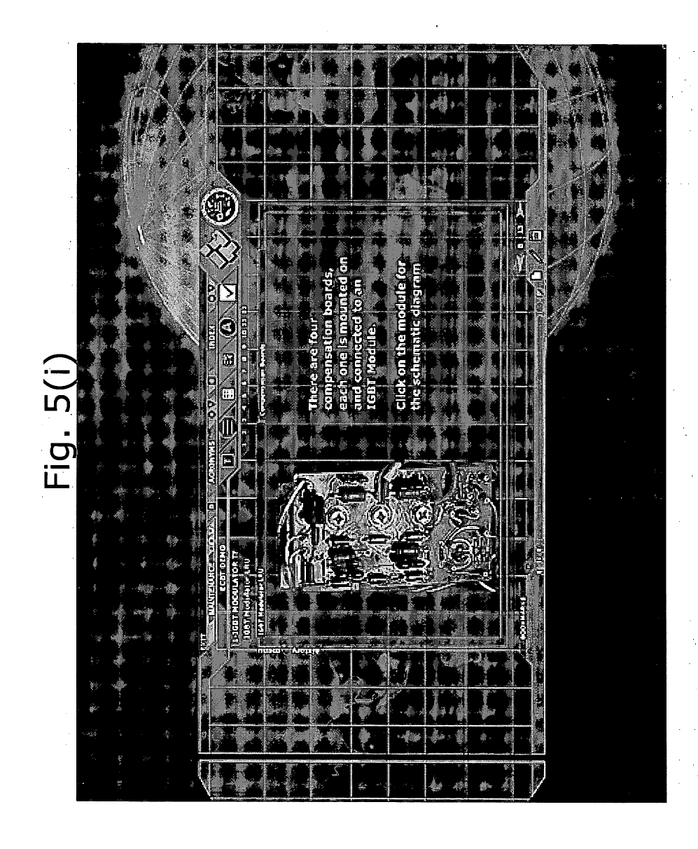

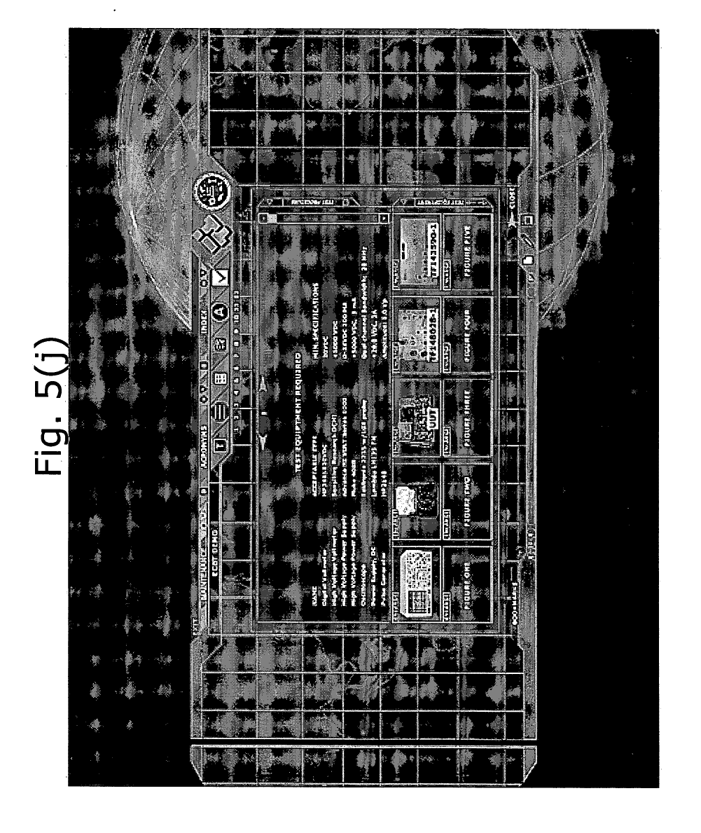

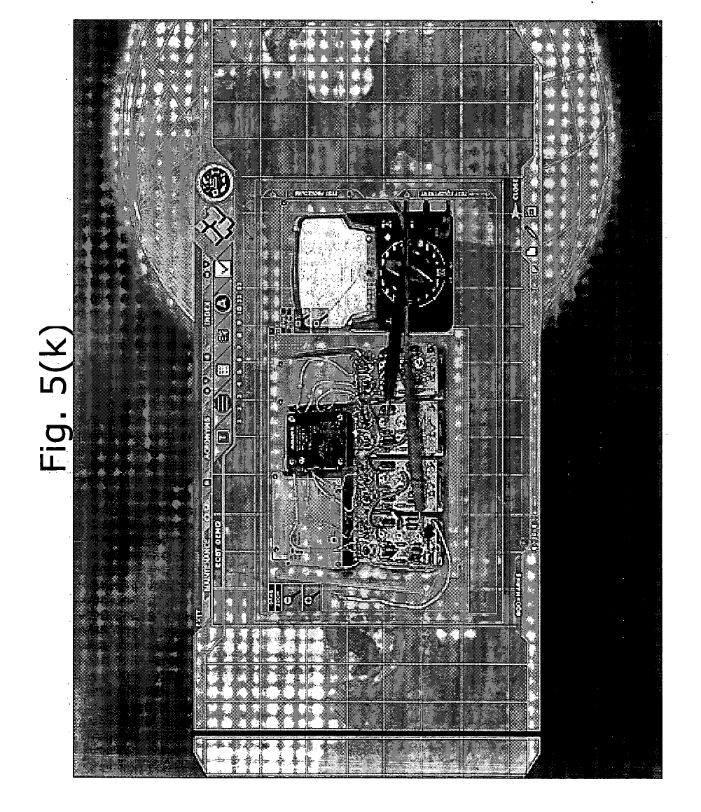

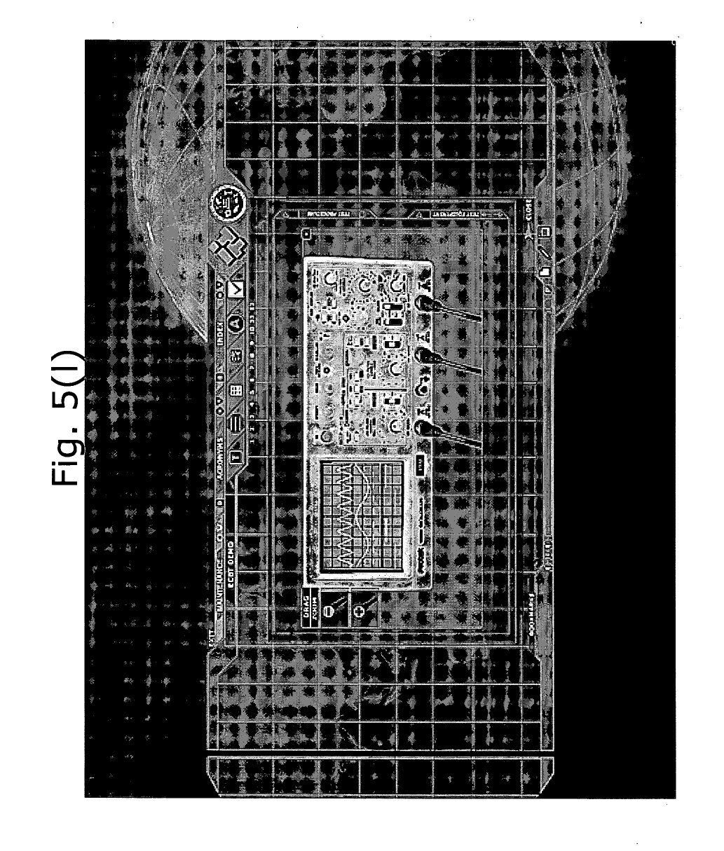

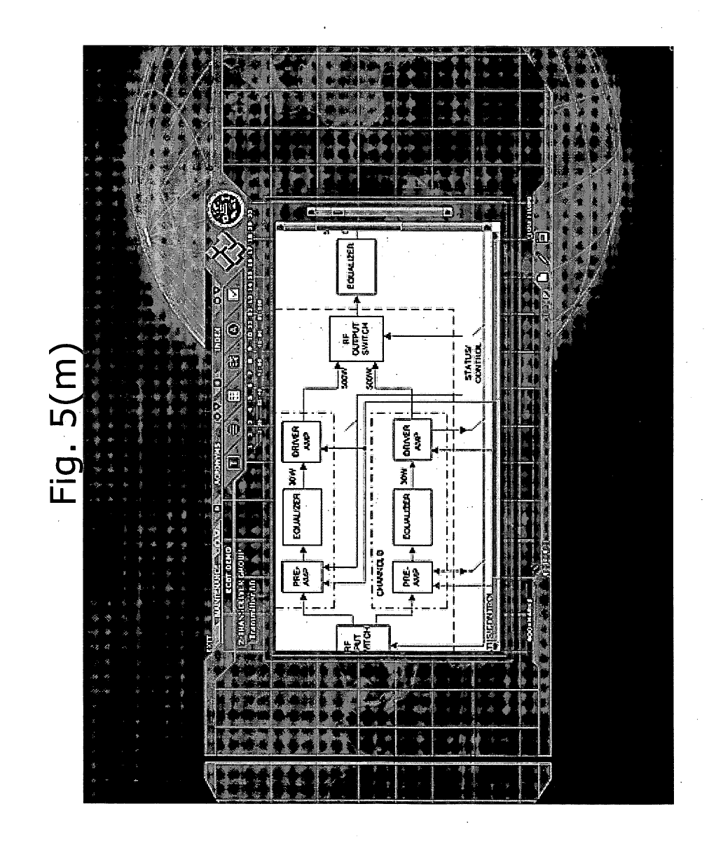

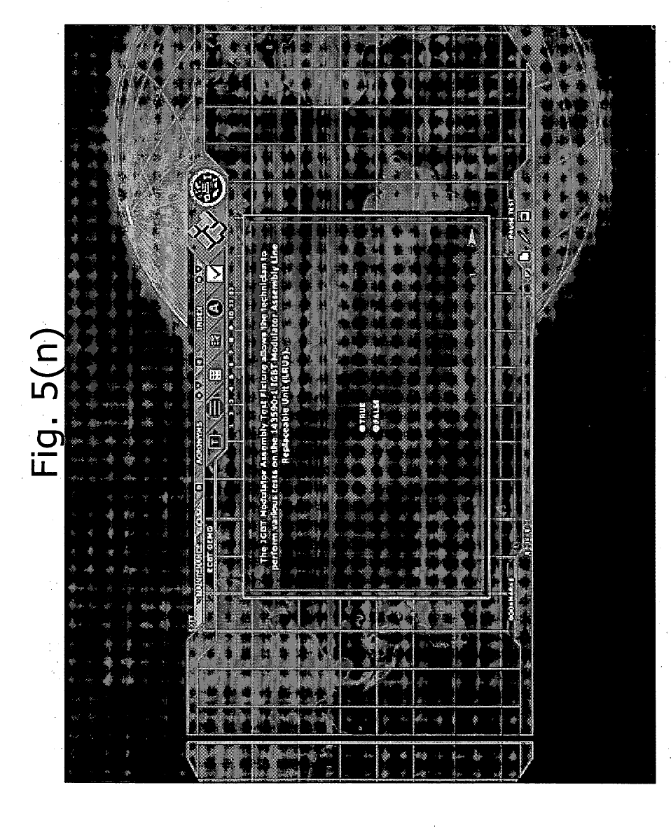

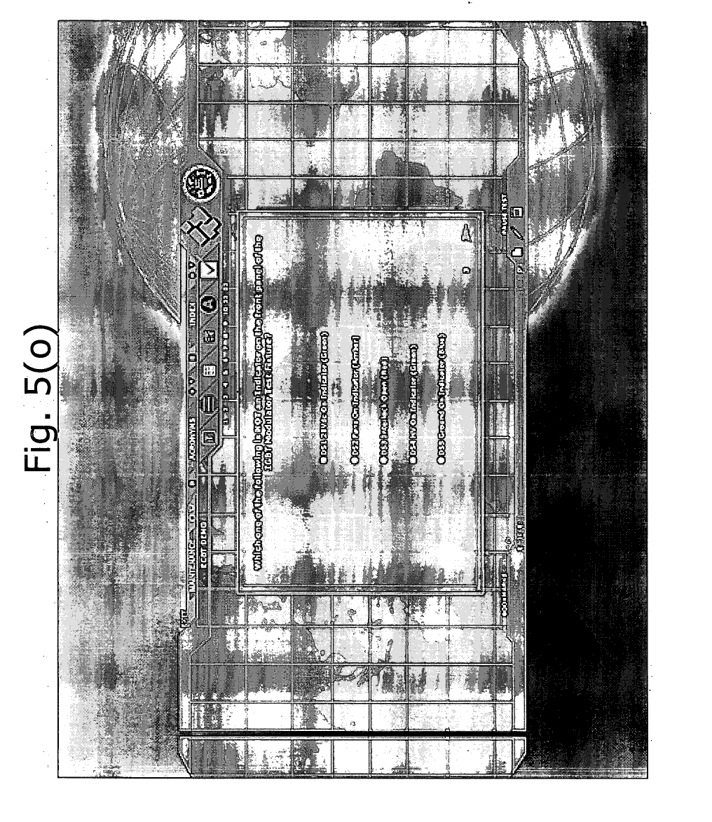

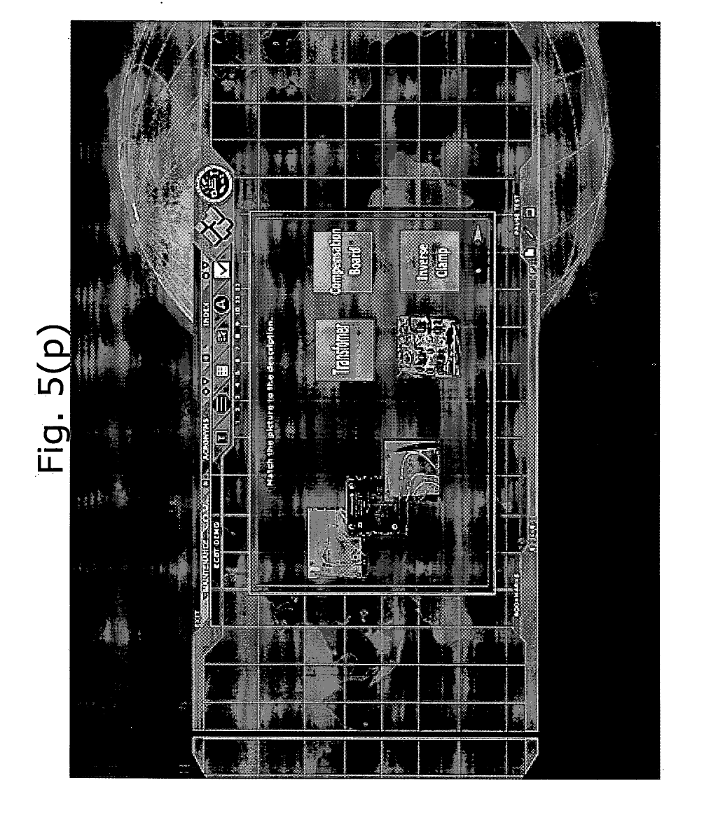

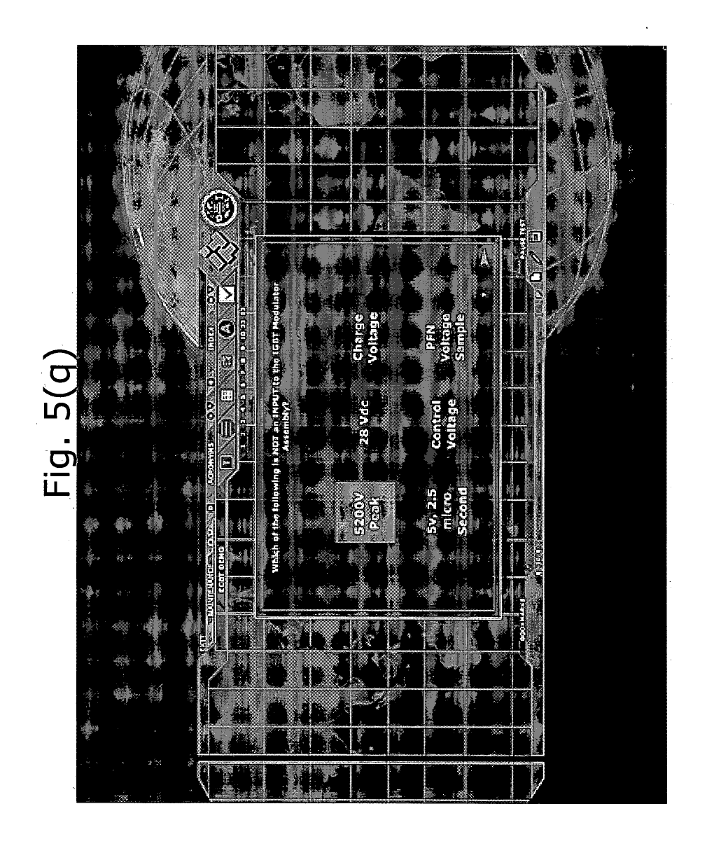

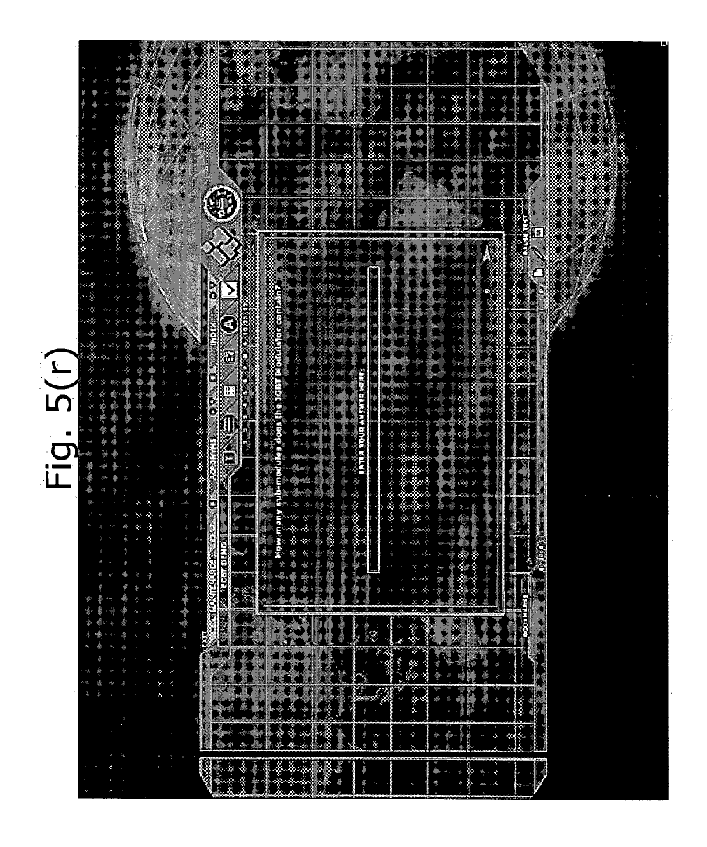

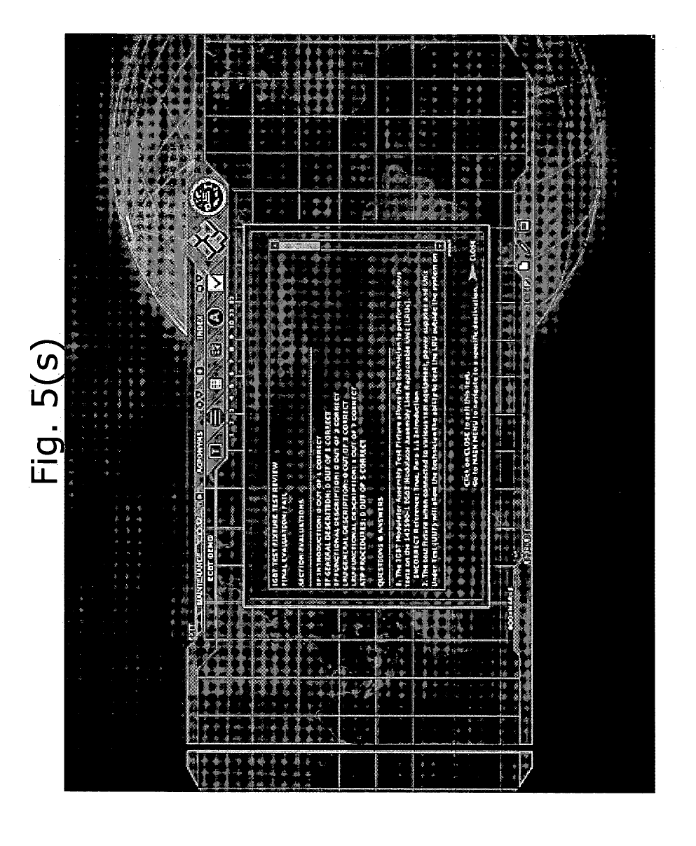

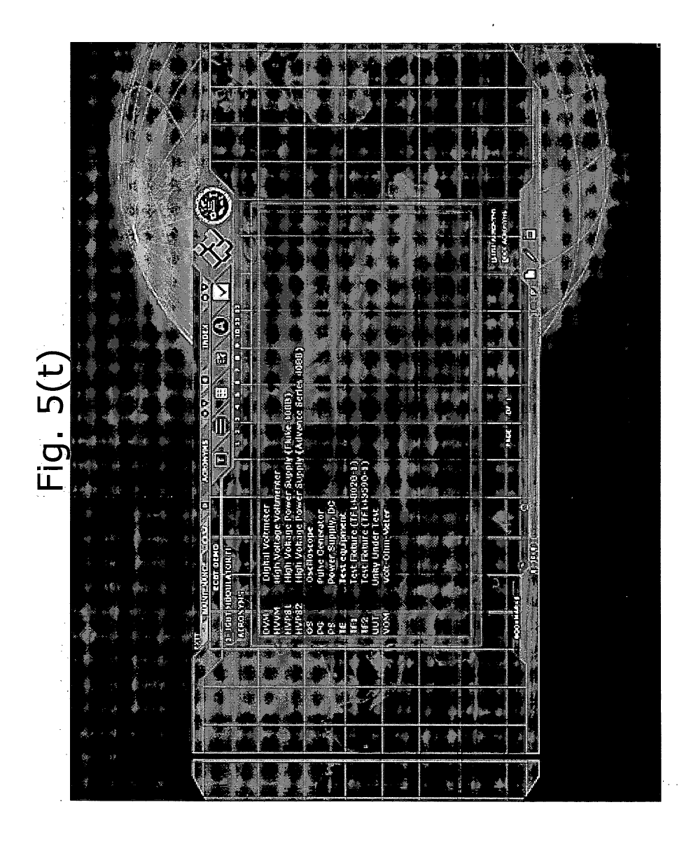

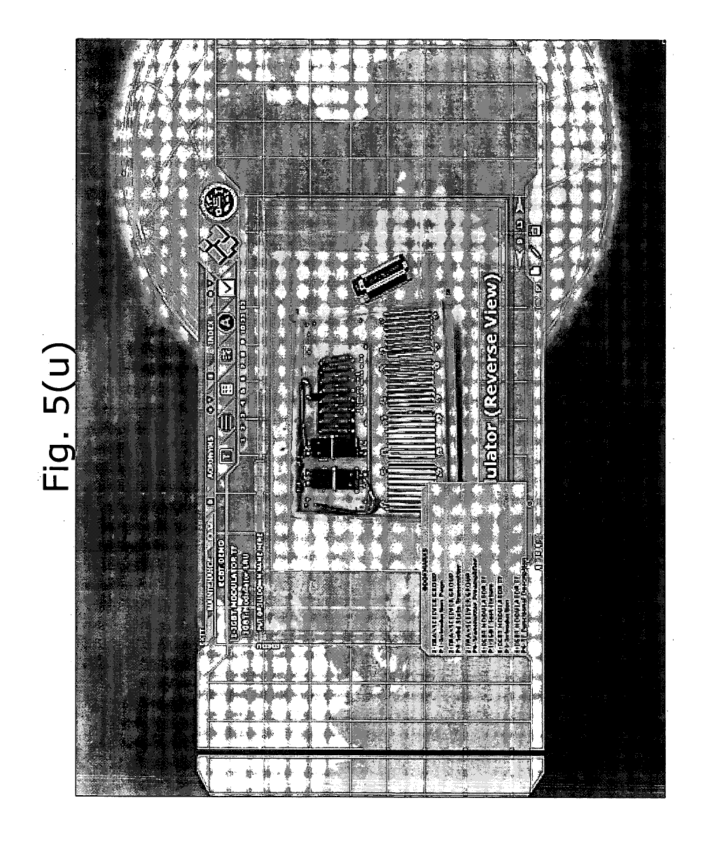

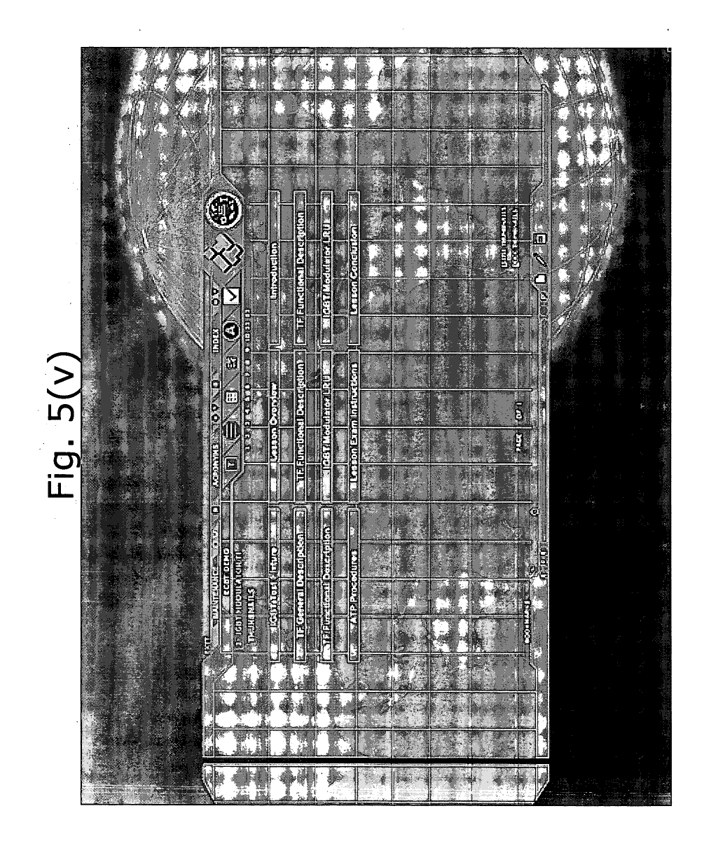

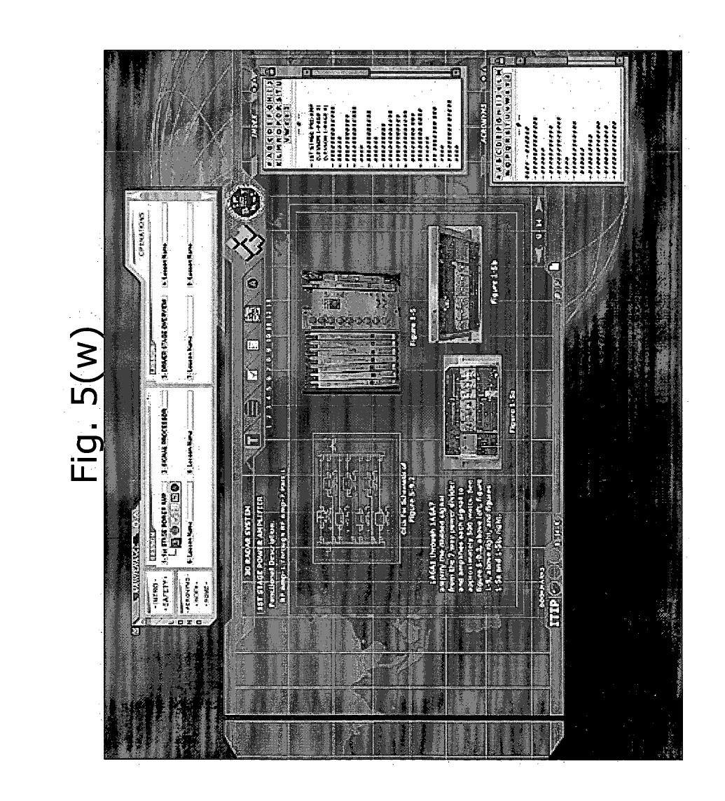

Splash Page: When the user starts the ECBT 120, a splash page is displayed on the computer monitor 108 (see, e.g., FIG. 5(a)). The user may exit the application from the splash page by selecting on the EXIT button located on the lower left of the image. The user may select the following options:

Load Audio. This option, once selected, may be redefined while in the application.

Full Screen. Launches the application to populate the entire screen.

Scaleable. If Full Screen is set to “No” and Scaleable is selected, the user can scale the application as desired, providing for other applications to be used simultaneously. If Scalable is not selected, the ECBT cannot be scaled and the application populates an 800×600 area of the screen.

Operation of the Application:

The ECBT is based upon structural templates which may include a base template, a primary template, a login template, a Main Menu template, a Panels template, two lesson templates, Component templates (twelve in a preferred embodiment, six per course), including two Thumbnails templates, two Warnings templates, two Procedures templates, two Figures templates (and two additional sub-Figures templates), two Acronyms templates, and two Examination templates.

The ECBT may be implemented with certain so-called hotkeys, e.g., as described here:

| | Hot Key/Effect |
|---|---|
| Main Menu | “m” opens/closes the Short Menu |
| | Spacebar- opens/closes the Long Menu. |
| | “m” opens the Short menu and closes the menu |
| | whether in Short menu mode (locked or not), or in |
| | Long menu mode. |
| | Spacebar opens the Long menu whether the menu is |
| | completely closed or in Short menu mode. If Short |
| | menu open, Spacebar opens the Long menu, if |
| | pressed again closes only the Long menu while |
| | leaving the Short menu open. If Long menu is open |
| | and the MAIN MENU is locked, selecting on a link |
| | to a lesson or sub-category of a lesson automatically |
| | closes only the Long menu while leaving the Short |
| | menu open. |
| ACRONYMS | “a” opens/closes/unhides. |
| INDEX | “i” opens/closes/unhides. |
| Within | |
| Active | |
| Lessons | |
| Thumbnails | “t” to open, “c” to close, “d” to dock. |
| Warnings | “w” to open, “c” to close, “d” to dock. |
| Examination | “e” to open. Closing via completion or deliberate |
| | action (mouse select followed by verification action |
| | requiring mouse select), “d” to dock. |
| Procedures | “p” to open, “c” to close, “d” to dock. |
| Figures | “f” to open, “c” to close, “d” to dock. |
| Acronyms | “r” to open, “c” to close, “d” to dock |

Panels:
MAIN MENU Panel: (FIG. 5(a))

Top level operations available on the MAIN MENU include the following:
EXIT PROGRAM button (square). The EXIT PROGRAM button, if selected, closes the application.
Menus To Default button (circular). If the MAIN MENU and/or the ACRONYMS and INDEX panels have been dragged to a user-defined location on the screen, the Menus to Default button closes and reset all panels to their default state and location.
MAX/MIN button (triangular) opens and closes the MAIN MENU panel.
Alternatively, pressing the keyboard hotkey “m” opens or closes the MAIN MENU (CAPS LOCK must be off).

When opened, the MAIN MENU displays links to information, lessons, and other operations such as the HOME function and links to call up the Acronyms and Index panels if they have been hidden. The HOME button returns the user to the HOME page. Configuration of panels are unaltered, and any of the dockable subject matter is set to or remains at its docked state. When the MAIN MENU is opened, a Lock/Unlock Menu button is available (a lock icon is also applicable to the ACRONYM and INDEX panels). With regard to a CD-ROM-based application, in cases where screen size and resolution provide a larger viewing space, the MAIN MENU, ACRONYM, and INDEX panels may be dragged to a desired location on the screen. The MAIN MENU may be locked. The Lock/Unlock button, if set to Lock, prevents the panel from automatically closing when a lesson or panel link is activated. Once locked, a panel may be unlocked by selecting the Lock icon to set to unlock. Buttons that override the locked state are the Menus To Default button, MIN button, and the keyboard hotkey “m”.

The MAIN MENU preferably has a short version (default) and a long version, which extends the menu size to near the full length of the application. The long version may be opened and closed by selecting the LONG/SHORT buttons respectively (left side on Main Menu), or by pressing the space bar (once to open, again to close).

The arrows pointing up and down on the right side of the MAIN MENU move to the next selection set of lessons (either SHORT or LONG menu). Selecting the down arrow moves to the next selection set of lessons until the end of the lesson list is reached. Selecting the up arrows moves to the previous set of available lessons. The Up and Down keyboard cursor keys also perform this function.

To bring up the desired lesson, select on the appropriate link within the MAIN MENU panel. The lesson is activated and the MAIN MENU panel automatically closes unless it is locked in the open position. Rolling over the lesson name reveals categories of material pertaining to the lessons. In presently preferred embodiments of the invention, the categories are Thumbnails (taking the user to a page of page titles of all pages within the lesson that are links that take the user to the associated page in the lesson), Warnings, Examination, Procedures (taking the user to a page of procedures titles of all procedures within the lesson that are links that take the user to the associated procedure in the lesson), Figures (taking the user to a page of Figures names of all Figures within the lesson that are links that take the user to the associated Figure in the lesson), and Acronyms. These icons are either active or inactive, depending on the lesson being rolled over. Lesson categories that are active (the lesson has material applicable to it within the category) have identifying rollovers. Selecting on an active category link takes the user directly to that lesson material. This provides the user with the ability to go directly to any active lesson category of any lesson in the application directly from the Main Menu.

Global ACRONYM and INDEX Panels

For the MAIN MENU, ACRONYM, and INDEX panels, opening a closed panel automatically closes any unlocked open panel. Locked panels are not closed in this manner. This functionality minimizes unnecessary user interaction requirements during conditions when the panels are not dragged off the main stage area (monitor size and screen resolution determine the availability of this capability). If panels are dragged off the main stage area, locking them allows the panels to remain open and accessible at all times.

Top level operations available on the Acronym and Index panels are:

Hide button (square). Hides the particular panel.

Menus To Default button (circular). If the MAIN MENU and/or the ACRONYMS and INDEX panels have been dragged to a user-defined location on the screen, the Menus to Default button closes and resets all panels to their default state and location.

MAX/MIN button (triangular) opens and closes the respective panel. Alternatively, pressing the keyboard hotkey “a” opens or closes the ACRONYM panel. Pressing the keyboard hotkey “i” opens or closes the INDEX panel.

Lessons

The lesson title and page titles are displayed in the title section located in the upper left portion of the interface below the application module title. In all cases, the title section should display the title and subtitle of the subject matter being displayed on the main stage, whether a lesson, figure, lesson component, etc.

To the right of the title section is the same set of six icons that are also represented when rolling over a lesson's name in the MAIN MENU. These icons are linked to information applicable specifically to the lesson displayed. They, again, are thumbnails (taking the user to a page of lesson page titles of all pages within the lesson that are links that take the user to the associated page in the lesson), warnings, examination, procedures (taking the user to a page of procedures titles of all procedures within the lesson that are links that take the user to the associated procedure in the lesson), figures (taking the user to a page of figures names of all figures within the lesson that are links that take the user to the associated figure in the lesson), and acronyms. These icons are either active or inactive, depending on the lesson being displayed. Active icons are large and have a rollover state identifying the button's function. Inactive icons are smaller and without a rollover state.

Moving from page to page (forward or reverse) is accomplished by either selecting on the directional arrows within each lesson located in the lower right portion of the interface, or by the use of the right and left keyboard cursor keys. Between the directional arrows is an indicator that tells the user the page number of the lesson that is displayed (the left hand number) and the total number of pages in that lesson (the right hand number).

Content placement may be one of five presentation templates:

Images (scrollable) from the top to midway of the stage and text (scrollable) from midway to the bottom of the stage.

Images (scrollable) from the left side of the entire stage and text (scrollable) from the right side of the entire stage.

Text (scrollable) occupying the entire stage.

Images (scrollable) from the left side of the entire stage and two separate sets of text (scrollable) from the right side of the stage.

Static Text, or Image(s), or combination, or a Macromedia Flash (.swf) file.

Drilldowns

Drilldowns are an additional component may be sourced from any page of a lesson. There may be as many drilldowns on as many pages as required in a lesson. In a present implementation, each drilldown component has the ability to provide up to nine hundred and thirty one (931) pages of information. The drilldown component is based on structural templates. Structural templates include the base template, the control template, and the sublevel templates. Drilldowns have three levels of information presentation, consisting of the presentation page, the sublevel components, and the pages within each sublevel. In a present implementation, the presentation page can have up to thirty (30) links that can launch individual associated sublevels, and up to thirty (30) rollovers that provide information. Each sublevel can have up to thirty (30) links to up to thirty (30) pages of information within that sublevel, and up to thirty (30) rollovers that provide information. Each page of a sublevel can have up to thirty (30) rollovers that provide information. Each page of a drilldown can use one of four (4) presentation templates:

Static Text, or Image(s), or combination.

Image(s) from the top to midway of the stage and text (scrollable) from midway to the bottom of the stage.

Image(s) from the left side of the entire stage and text (scrollable) from the right side of the entire stage.

Text (scrollable) occupying the entire stage.

Skimmer:

A Skimmer located near the top of the content stage area consists of a set of page numbers in the lesson. The user can move directly to any page in a non-linear fashion by selecting on a desired page number.

Docking:

Information categories applicable to a specific lesson in the form of thumbnails, warnings, examination, procedures, figures, and acronyms are dockable and can therefore be called up from its docked state for review. The user can put one of each set of said information in a docked state that provides access to it regardless as to whether the applicable lesson is in on the main stage. The information docked does not have to apply to a single lesson. Lesson components in any of the six component categories may be docked at one time (five sets of information per category).

Reviving docked information may be done by selecting the docked information's icon located in the lower portion of the interface. Rolling over the icon displays the category of information docked and the lesson it applies to. Selecting the applicable icon within the current lesson also revives docked information if the docked information is applicable to the lesson. If the category of docked information being displayed is applicable to a different lesson than the lesson being displayed, selecting on the same category icon within the displayed lesson automatically docks the current displayed information and display the information associated with the displayed lesson.

Any dockable asset previously docked will automatically dock if, while the docked asset is populating the main stage area, the link to a lesson or lesson sub-category is selected. Each time a docked asset is on the main stage, the user can choose to either dock it or close it. In the case of a docked set of thumbnails, if a thumbnail page of the associated lesson is selected, the thumbnails automatically docks and the page selected populates the main stage area. The same applies to procedures, and figures.

In the event that all docking spaces within a particular category is full (in preferred embodiments of the present invention, all five dock spaces for that category are occupied), if the user attempts to dock another asset of that same category, a choice page pops up. This provides the user with the ability to replace one of the existing docked assets with the one the user is attempting to dock, or the user can close out of the docking attempt and keep those assets within that category that are docked.

Once an asset is docked, the only way to remove it from a docking space is to bring it up onto the main stage area and close it, or replace it with another asset as described above.

Bookmarks:

The user has the capability to bookmark an individual page of any lesson (in a present implementation, up to eighteen bookmarks may be stored). The user can select on the Bookmark link in the Bookmark Panel to go directly to the bookmarked page. As with Docking above, once all bookmark spaces are filled, further attempts to bookmark results in a choice page popping up. This provides the user with the ability to replace one of the existing bookmarks with the one the user is attempting to bookmark, or the user can close out of the attempt and keep those bookmarks currently in the list.

Resetting the Application:

To reset the application to the initial default state, an invisible reset button is located over the two logos in the upper right portion of the interface. All lesson material and panels are closed and reset to their default location and dockable items are closed and unloaded.

Launching Other Applications:

Buttons may be placed in an area located in the lower left side of the application. These buttons may be programmed to launch additional training or information applications as well as third party applications.

Capabilities

The programming is such that there is support for the capabilities provided for within the CBT in terms of the effects of information access and sequence of information activation. The integrity of the access sequence to particular information is maintained as the user drills down to information within a lesson.

Example: For example, if page 36 of Lesson One is being displayed and the user then accesses the Figures category page for Lesson Forty through the MAIN MENU, although the Figures category page for Lesson Forty populates the stage area, Lesson One is not closed out. Upon either closing or docking the Figures category page for Lesson Forty, page 36 of Lesson One is displayed.

Example: As another example, if page 28 of Lesson Thirty Three is being displayed and a link to a particular figure resides on that page and the user selects on that link, the individual figure populates the stage area. Upon closing that individual figure, page 28 of Lesson Thirty Three will return. If, however, the user selects on the figures icon of Lesson Thirty Three, that lesson's Figures component page (providing links to all figures applicable to that particular lesson) will populate the stage area. Accessing an individual figure through one of the links provided in the Figures component page automatically docks the Figures page and brings up the activated figure. Upon closing the figure, the Figures component page is automatically undocked and populates the stage area, thus allowing the user to choose another figure if desired. Either directly docking or closing the Figures page revives page 28 of Lesson Thirty Three.

FIG. 5(w) is an image is of a CD-ROM. ECBT set to Full Screen on a 21″ monitor at a resolution of 1280×1024. The MAIN MENU, ACRONYMS, and INDEX panels have been opened and dragged around the perimeter of the 800×600 main stage, providing immediate access to information and links.

The various components provide a user extensive control, as well as providing non-destructive interaction between elements. Access and control of information is greatly enhanced and direct.

The Logon/Password splash page component defaults to focus keyboard input at the Logon and Password input text fields. If the user selects (e.g., clicks the cursor) anywhere on the screen, focus is removed from the input text fields and must be re-established by selecting on the input text fields. A blinking cursor may be used to indicate proper keyboard focus. In a presently preferred exemplary embodiment, if the user makes three input errors, the application closes down and needs to be re-initialized.

The Main Menu system is preferably enhanced to be draggable and lockable and include direct links to each lesson as well as direct links to individual lesson elements. In some embodiments of the present invention, the main menu system may be enhanced to expand to almost full standard stage size (800×600), providing direct access to forty eight lessons at a time. Preferably the system provides non-destructive interaction.

In presently preferred embodiments of the invention, individual lessons may be accessed using a main menu system providing basic navigational functionality which provides access to individual lessons through links. In some embodiments of the present invention, there are two introductory or general subject information lesson links located on the left side of the main menu. The main lesson links are located in the main body of the main menu.

In some preferred embodiments of the present invention, two expandable/collapsible, draggable, and hideable global information panels are available to the user (typical uses of these panels are a global acronyms list and a global index list).

Additional lesson elements may be included and are accessible categorically from within each lesson, and also may be accessed independently directly from the main menu. This includes thumbnails of pages within each lesson, as well as warnings, testing, procedures, figures, and acronyms component pages, where applicable.

All individual lesson category elements are preferably dockable (e.g., in some embodiments of the present invention five components from each category may be docked), providing for access independent from the active lesson. The system provides non-destructive interaction with other elements of a lesson.

Individual pages within a lesson are accessible through mouse select or cursor key interaction.

In presently preferred embodiments of the invention, individual pages can hold a drilldown component. In some embodiments the drilldown component is capable of holding up to 931 pages of information for each drilldown.

Individual pages within a lesson may be bookmarked using a bookmark button, providing for access to bookmarked pages located in the bookmark panel at any time through links.

A link is provided at the end of each lesson that moves the user to the next lesson.

Other controls include Audio controls (Play, Stop, Rewind), digital clock (on cursor rollover), printing function, text editor launch button (typically launches WordPad), and an email editor launch button.

### EXAMPLE

An example operation of an ECBT implemented according to embodiments of the present invention is now described with reference to the screens/GUIs depicted in FIGS. 5(a)-5(v). This example is provided for explanatory purposes only, and is not meant to limit the scope of the invention in any manner.

In operation, a user loads and starts the program in a known, conventional manner.

The user is presented with an initial screen which provides for course/category selection. Once a category is selected, a selection popup appears. The user is presented with “yes”, “no” options which may be facilitated by selecting on the “Yes” or “No” buttons or by using the “y” key for “yes” or the “n” key for “no”. First, this popup provides the user to define initially whether audio will be loaded. This popup also provides the user with the ability to decide whether the application is to be launched full-screen. Launching the application full screen is generally only appropriate and beneficial if the monitor has sufficient resolution (e.g., 1152×864 pixels, or more). FIG. 5(a) depicts a course selection and configuration page according to embodiments of the present invention.

In the main stage header area are three main panels, the main menu panel, the acronyms panel, and the index panel. The main stage footer area holds the bookmarks panel, a clock, audio controls, printing, bookmarking, a workpad and e-mail functions. Clicking on the “exit” text in the upper left exits the application.

Main Menu

In collapsed mode, only three buttons are visible/evident in the Main Menu panel header. Clicking on the “exit” text in the upper left of the Main Menu panel exits the application. Rolling over the center of the panel header provides the main menu to be dragged. The circular button sets all menus to their default positions. To open the main menu panel, use the triangular button or use the “m” key. Once open, the user is provided with two buttons on the far left side of the main menu panel. The first is used to lock the menu in the open position and is in the shape of a padlock. This is generally useful only when the main menu is dragged off the main stage header area. The second button opens the long mode of the main menu. The user can extend to long mode by pressing the word “long” or by pressing the space bar. Once in long mode, the user can press the “short” button or press the space bar a second bar a second time to move back to short mode. To close the main menu completely from either mode, press the triangular button or the “m” key. If the main menu is closed completely, opening and closing the main menu in long mode may be done by pressing the space bar.

The upper right side of the main menu panel offers a link to the remaining subject category. This provides the user with the ability to toggle back and forth between subject categories at will. Also on the upper right side are arrow keys provide the user to access different pages of the lesson links. This can also be controlled by the up and down cursor keys.

Rolling over a lesson title exposes six additional lesson-specific icons. This lesson-specific categories are: “thumbnails”, “warnings”, “procedures”, “figures”, “acronyms” and “exams”. Clicking directly on an active category icon loads that lessons category information. Clicking directly on a lesson title loads that lesson on the main stage area.

FIG. 5(b) depicts a category 1 homepage. FIG. 5(c) depicts a main menu open in default unlocked mode, and panels in default mode. FIG. 5(d) depicts a main menu, index, and acronyms panels open in expanded locked mode.

Panels

The two remaining header panels are the “acronyms” and “index” panels. The upper portion of the “acronyms” and “index” panels hold alphabetical buttons that load pages of associated content. An index may use links that directly load specific content onto the main stage. When monitor size and resolution provide, the acronyms, index and main menu panels may be dragged off the main stage area and locked in the open position. FIG. 5(t) depicts a lesson Acronyms component.

Components

Within the main header bar are six icons representing component categories of which a lesson may have associated information. These lesson-specific categories are the same as those found in the main menu. They again are: “thumbnails”, “warnings”, “procedures”, “figures”, “acronyms” and “exams”. Clicking directly on an active icon loads the associated information onto the main stage area. The “thumbnails” component provides a user with page titles and links for each page of the lesson. The “warnings” component lists all associated warnings. The “procedures” component provides all titles of and links to all procedures associated with the lesson. The “figures” component provides a user with all names of and links to all available scalable figures. The “acronyms” component brings up all acronyms used. The “exams” component brings up an exam, with questions based on information contained within the lesson.

Docking

The user can dock lesson components for later reference. There are five docking stations for each component category. Once all five stations of a category are filled, attempting to dock a sixth brings up a selection page. The user can choose to replace a docked component or close out the selection page.

Bookmarks

The user has the ability to bookmark a number of pages (up to eighteen in a present implementation) for future reference. FIG. 5(u) depicts a bookmarks panel.

Lessons

When a lesson is loaded, the lesson name and lesson header information are presented in the upper left. The user can move from page to page in a linear fashion by clicking on the directional arrows in the lower right or by using the left or right cursor keys. The user can also go directly to a specific page by using the page number bar located below the main stage header area. The lesson content in the main stage header area holds text and images. On some pages, the images have buttons that load scalable versions of that image.

FIG. 5(e) depicts a lesson template 1 with menu and panels in default mode. FIG. 5(f) depicts a Lesson Template 2. FIG. 5(v) depicts a lesson page titles component.

Drilldowns

Drilldowns are provided to further enhance the training process. Drilldown sublevels and pages may be accessed by rolling over the menu button within the drilldown located near the lesson name. This reveals the submenu of items that the user can further review. This submenu can hold up to thirty (30) different items at one time from which the user can navigate at their discretion. Rollovers can also be provided to further enhance the learning experience. Diagrams can also be accessed by clicking on the image.

FIG. 5(g) depicts a drilldown start page. From this page, up to 30 Sub-Levels may be accessed. FIG. 5(h) depicts a drilldown start page with drilldown menus opened. The menu lists all sub-levels and associated pages available. FIG. 5(i) depicts a drilldown to the first sub-level. Each Sub-Level can include up to 30 pages of information. FIG. 5(m) depicts a scaleable schematic/figure component.

Procedures

Test procedures may be included within a lesson. To access a procedure, select the procedure button. The applicable procedure splash page appears. Clicking on the inner arrow in the lower right reveals the procedure content. The procedure includes a list of required equipment and instructions. The instructions may be expanded by clicking on the expand button. Navigating through pages may be achieved by clicking on the left and right arrows or by using the cursor arrow keys. Also included are images of the equipment involved. The images may be enlarged and dragged as needed.

FIG. 5(j) depicts a procedure component launch page. FIG. 5(k)-5(l) depict procedure components with interactive simulation.

Exams

A lesson exam may be taken by clicking on the exam icon. The user is required to logon and enters a user id and student name to do so. An exam can contain any number of questions. In a presently preferred embodiment, an exam can contain up to one hundred questions. A question may be of a number of types, including: true/false, multiple choice, fill in the blank, drag and drop, and hot spot. Upon completion of all questions, a report is generated which notifies the user of their score. Additionally, for any questions scored incorrectly, a reference to the subject matter is provided. A report may be printed by clicking on the print button in the lower right. Clicking on the close button sends the user back to the first page of the lesson.

FIG. 5(n) depicts a test question true or false question format (one of five formats). FIG. 5(o) depicts a test question multiple choice format. FIG. 5(p) depicts a test question in Drag and Drop format. FIG. 5(q) depicts a test question in Hot Spot format. FIG. 5(r) depicts a test question in Fill-In format. FIG. 5(s) depicts a test report page.

Aspects of this invention relate to GUIs for creating and using ECBT content. The scope of the invention is not limited by the particular GUIs presented or their implementations. In particular, the positions and choices of screen icons, interfaces and display regions are design choices that may be made within the context of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. A system for computer-based training (“CBT”) comprising:
a content editing portal, operable on a computer system, for generating content using a markup language, the portal providing a graphical user interface (“GUI”) to give a user access to the markup language data in a structured form-based editing environment.

2. A system as in claim 1 wherein the portal comprises:
computer code to support making changes to the content;
computer code to support creating an index of the content;
computer code to support associating a procedure with a page of content;
computer code to support adding audio to the content; and
computer code to support adding titles to the content.

3. A system as in claim 1 wherein the content are stored using templates, and wherein the GUI supports reassigning the content from a first template to a second template by selection of a template tab corresponding to the second template.

4. A system as in claim 1 wherein the GUI includes a page preview area.

5. A system as in claim 1 wherein the content editing portal includes an acronyms module which supports the creation of a list of acronyms.

6. A system as in claim 1 wherein the content editing portal includes a testing module which supports the creation of tests.

7. A system for computer-based training (“CBT”) comprising:
a content editing portal, operable on a computer system, for generating content using a markup language, the portal providing a graphical user interface (“GUI”) to give a user access to the markup language date in a structured form-based editing environment, wherein the portal comprises:
computer code to support making changes to the content;
computer code to support creating an index of the content;
computer code to support associating a procedure with a page of content;
computer code to support adding audio to the content;
computer code to support adding titles to the content;
an acronyms module which supports the creation of a list of acronyms; and a testing module which supports the creation of tests, and wherein the content are stored using templates, and wherein the GU supports reassigning the content from a first template to a second template by selection of a template tab corresponding to the second template.

8. A system for computer-based training (“CBT”) comprising:
a presentation mechanism constructed and adapted to present a lesson to a user, the lesson having been stored using structural templates including at least one lesson template and at least one testing template, the presentation mechanism presenting a plurality of panels, including a global acronym panel.

9. A system as in claim 8 further comprising:
a drilldown mechanism constructed and adapted to provide a user with additional pages of information related to a selected topic.

10. A system as in claim 9 wherein the drilldown mechanism is based on structural templates which include a base template, a control template, and a sublevel template.

11. A system as in claim 10 wherein drilldowns support at least three levels of information presentation, comprising a presentation page, sublevel components, and pages within each sublevel.

12. A system as in claim 11 wherein the presentation page can have a plurality of links that can launch individual associated sublevels, and a plurality of rollovers that provide information.

13. A system as in claim 12 wherein each sublevel can have a plurality of links to a corresponding plurality of pages of information within that sublevel, and a plurality of rollovers that provide information.

14. A system as in claim 13 wherein each page of a drilldown can use one of a plurality of presentation templates.

15. A system as in claim 8 wherein the structural templates include a plurality of component templates and wherein the presentation mechanism further comprises:
a docking mechanism constructed and adapted to support docking a structural template, whereby a user is provided with access to a docked structural template from other pages.

16. A system as in claim 15 wherein, within a current lesson, selecting an applicable icon relating to a docked template:
(a) revives the docked template if a category of the docked template is applicable to the current lesson; and otherwise
(b) if a category of the docked template is applicable to a lesson other than the current lesson, docks the current displayed template and displays a template associated with the docked icon.

17. A system as in claim 15 wherein the component templates are selected from the group comprising: course templates, thumbnail templates, warnings templates, procedures templates, figure templates, acronyms templates and examination templates.

18. A system as in claim 8 further comprising at least on of the following:
(A) a bookmark mechanism constructed and adapted to provide a user with the ability to bookmark at least one location in a lesson and to move within a lesson by selection of a bookmark; and
(B) a skimmer mechanism constructed and adapted to provide a user with the ability to move among pages of a lesson in a non-linear manner.

19. A system as in claim 8 further comprising at least one of:
(A) a panel mechanism constructed and adapted to provide a user with control over said plurality of panels, said control including the ability to lock and unlock panels and the ability to drag panels; and
(B) a rollover mechanism constructed and adapted to provide a user with information about a lesson when a user rolls over a name or icon representing the lesson.

20. A system as in claim 18 wherein the bookmark mechanism is further constructed and adapted to provide the user with an associated choice page if allocated bookmark space is full.

21. A system as in claim 16 wherein further, within a current lesson, selecting an applicable icon relating to a docked template:
(c) provides an associated Choice Page if allocated docking space is full.
